(19) United States
(12) Patent Application Publication
(10) Pub. No.: US 2026/0253814 A1
(43) Pub. Date: Aug. 27, 2026

(54) METHOD FOR MANUFACTURING MULTILAYER ELECTRONIC COMPONENT

(71) Applicant: SAMSUNG ELECTRO-MECHANICS CO., LTD., Suwon-si (KR)

(72) Inventors: Yong PARK, Suwon-si (KR); Kwan Soo PARK, Suwon-si (KR); Jong Ho LEE, Suwon-si (KR); Min Woo KIM, Suwon-si (KR); Jin Ho CHOI, Suwon-si (KR)

(73) Assignee: SAMSUNG ELECTRO-MECHANICS CO., LTD., Suwon-si (KR)

(21) Appl. No.: 19/407,351

(22) Filed: Dec. 3, 2025

(30) Foreign Application Priority Data
Feb. 27, 2025 (KR) 10-2025-0025454

(51) Int. Cl. H01G 13/00; H01G 4/224; H01G 4/30; H01G 4/005; H01G 4/12

(52) U.S. Cl. CPC H01G 13/003; H01G 4/224; H01G 4/30; H01G 4/005; H01G 4/12

(57) ABSTRACT

A method for manufacturing a multilayer electronic component includes: preparing a multilayer ceramic green sheet by stacking the ceramic green sheet in a first direction; preparing a green body by cutting the multilayer ceramic green sheet so that the internal electrode pattern is exposed in a third direction,; attaching a margin portion green sheet to the green body in the third direction under first process condition; and performing a punching process on the green body to which the margin portion green sheet is attached under second process condition, wherein, after the performing the punching process, the margin portion green sheet has a structure extending onto at least one of both surfaces of the green body in the first direction and both surfaces of the green body in the second direction.

### CROSS-REFERENCE TO RELATED APPLICATION(S)

This application claims benefit of priority to Korean Patent Application No. 10-2025-0025454 filed on February 27, 2025, the disclosure of which is incorporated herein by reference in their entireties.

### TECHNICAL FIELD

The present disclosure relates to a method for manufacturing a multilayer electronic component.

A multilayer ceramic capacitor (MLCC), a multilayer electronic component, may be a chip-type condenser mounted on printed circuit boards of various types of electronic products, such as an image display device, including a liquid crystal display (LCD) or a plasma display panel (PDP), a computer, a smartphone, or a mobile phone, serving to charge or discharge electricity therein or therefrom.

Such a multilayer ceramic capacitor has a small size, implements high capacitance, and is easily mounted on a circuit board, and may thus be used as a component of various electronic devices. There has been increasing demand for a multilayer ceramic capacitor to have a reduced size and higher capacitance as each of various electronic devices such as a computer and a mobile device have a reduced size and higher output.

To achieve miniaturization and high capacitance of a multilayer ceramic capacitor, maximization of an effective area of an electrode (an increase in an effective volume fraction required to realize capacitance) is required. When manufacturing a multilayer ceramic capacitor to implement a small-sized and high-capacity multilayer ceramic capacitor as described above, the multilayer ceramic capacitor may be manufactured so that an internal electrode is exposed in a width direction of the body, so that an area of the internal electrode in the width direction may be maximized through a margin-free design. In this case, a method in which a ceramic green sheet for a side margin portion is separately attached to an exposed surface of the internal electrode in the width direction and then sintered, to block exposure thereof to the outside, is applied.

As a side margin portion is formed by the method of separately attaching the ceramic green sheet for the side margin portion, capacitance per unit volume of the capacitor may be improved, but problems such as a shortened lifespan of a chip or defects may occur due to external moisture infiltration or plating solution infiltration during the plating process through an interface joint between the body and the side margin portion.

### SUMMARY

An aspect of the present disclosure is to provide a multilayer electronic component having improved moisture resistance reliability.

An aspect of the present disclosure is to provide a multilayer electronic component having improved dielectric properties per unit volume.

However, various problems to be solved by the present disclosure are not limited to the above-described contents, and can be more easily understood in the process of explaining specific embodiments of the present disclosure.

According to an aspect of the present disclosure, a method for manufacturing a multilayer electronic component may include preparing a ceramic green sheet having an internal electrode pattern formed thereon; preparing a multilayer ceramic green sheet by stacking the ceramic green sheet in a first direction; preparing a green body by cutting the multilayer ceramic green sheet so that the internal electrode pattern is exposed in a third direction, when a direction, perpendicular to the first direction is referred to as a second direction, and a direction, perpendicular to the first and second directions is referred to as the third direction; attaching a margin portion green sheet to the green body in the third direction under first process condition; and performing a punching process on the green body to which the margin portion green sheet is attached under second process condition, wherein, after the performing the punching process, the margin portion green sheet may have a structure extending onto at least one of both surfaces of the green body in the first direction and both surfaces of the green body in the second direction.

According to an aspect of the present disclosure, a method for manufacturing a multilayer electronic component may include preparing a ceramic green sheet having an internal electrode pattern formed thereon; preparing a multilayer ceramic green sheet by stacking the ceramic green sheets in a first direction; preparing a green body by cutting the multilayer ceramic green sheet so that the internal electrode pattern is exposed in a third direction, when a direction, perpendicular to the first direction is referred to as a second direction, and a direction, perpendicular to the first and second directions is referred to as the third direction; attaching a margin portion green sheet to the green body in the third direction under first process condition; and performing a punching process on the green body to which the margin portion green sheet is attached under second process condition, wherein the first process condition may include applying a pressure condition of 0.1 tons or more and 1.2 tons or less, and a temperature condition of 60°C or more and 120°C or less, and the second process condition may include applying a pressure condition of 5 tons or more and 12 tons or less, and a temperature condition of 20°C or more and 60°C or less.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a process flow diagram of a method for manufacturing a multilayer electronic component according to an embodiment of the present disclosure;

FIGS. 2A to 2G are perspective views or cross-sectional views schematically illustrating a method for manufacturing a multilayer electronic component according to an embodiment of the present disclosure;

FIG. 3 is a schematic perspective view in which a margin portion is attached to a body according to a method for manufacturing a multilayer electronic component according to an embodiment of the present disclosure; and

FIG. 4 is a schematic perspective view of a multilayer electronic component according to a method for manufacturing a multilayer electronic component according to an embodiment of the present disclosure.

### DETAILED DESCRIPTION

Hereinafter, some embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numeral are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawing, a Z-direction may be defined as a thickness direction or a first direction, an X-direction may be defined as a length direction or a second direction, and a Y-direction may be defined as a width direction or a third direction. A stacking direction may be a thickness direction or a width direction.

### Method for manufacturing a Multilayer Electronic Component

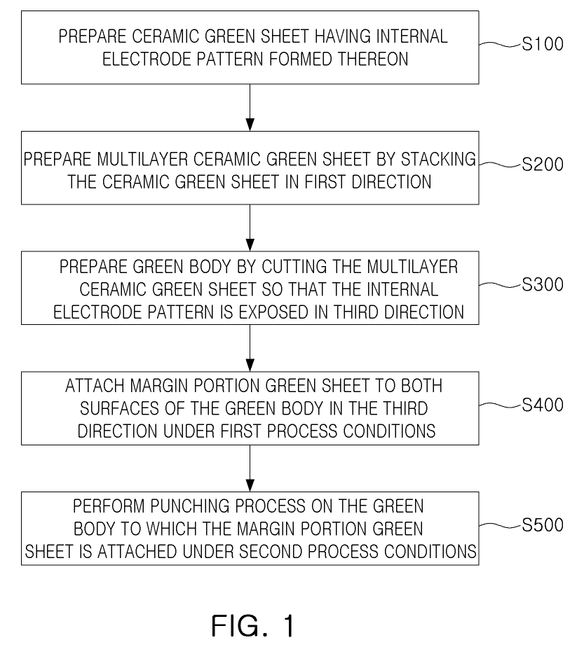

FIG. 1 schematically illustrates a process flow diagram of a method for manufacturing a multilayer electronic component according to an embodiment of the present disclosure.

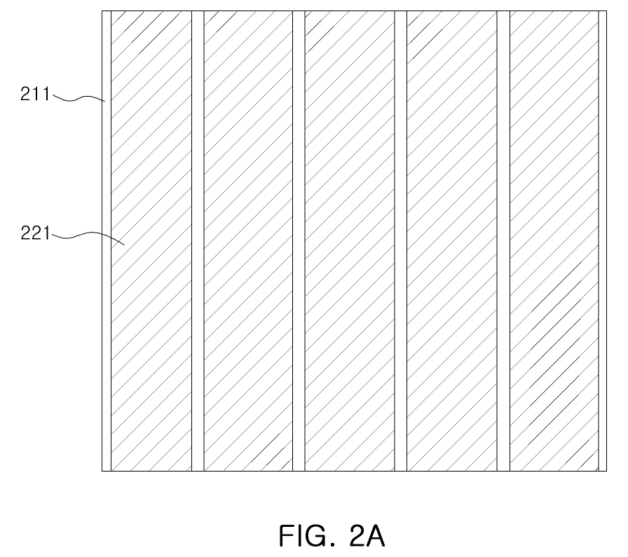

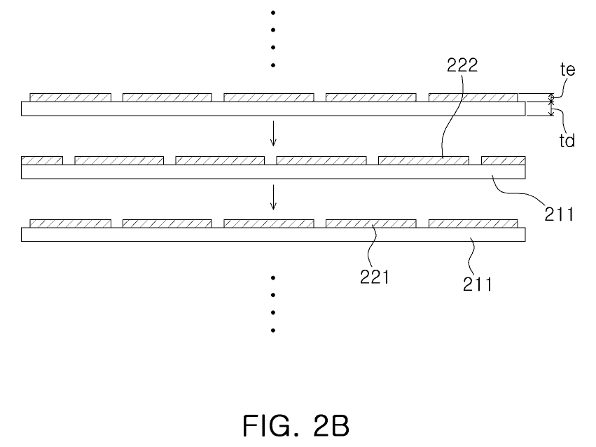

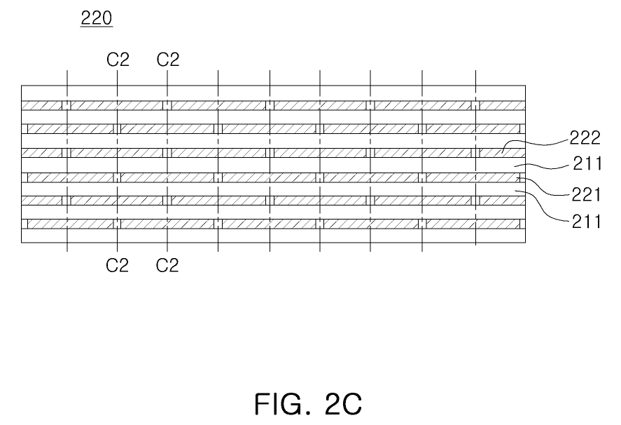

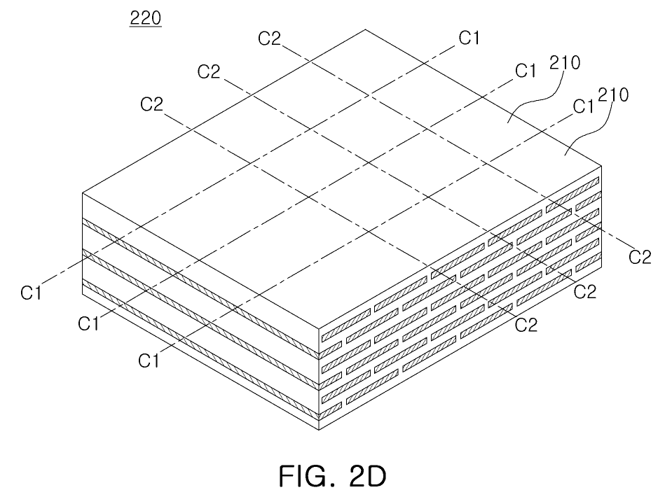

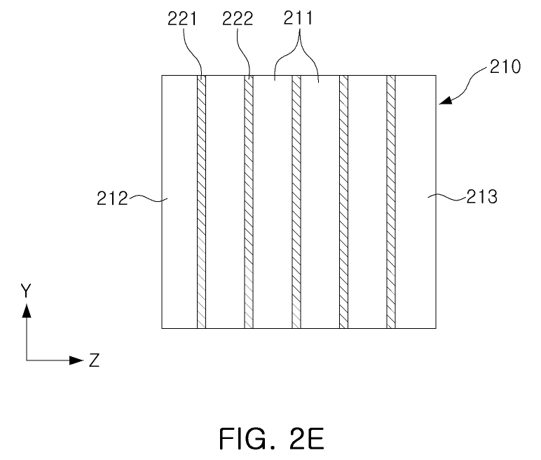

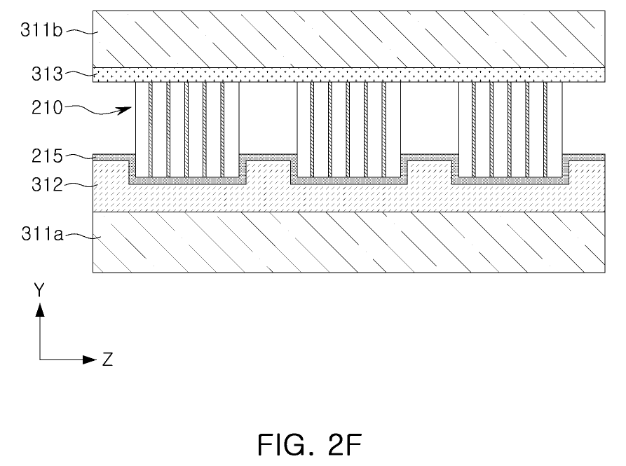

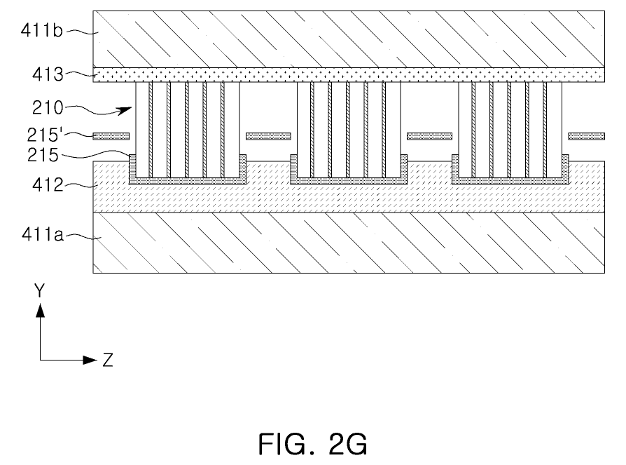

FIGS. 2A to 2G are perspective views or cross-sectional views schematically illustrating a method for manufacturing a multilayer electronic component according to an embodiment of the present disclosure.

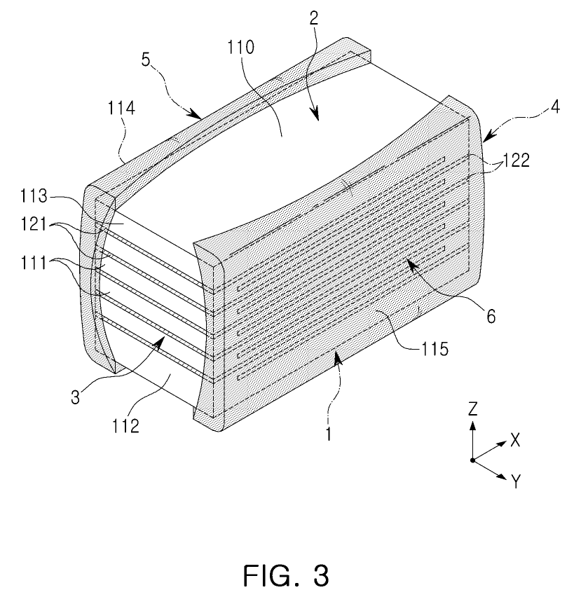

FIG. 3 is a schematic perspective view in which a margin portion is attached to a body according to a method for manufacturing a multilayer electronic component according to an embodiment of the present disclosure.

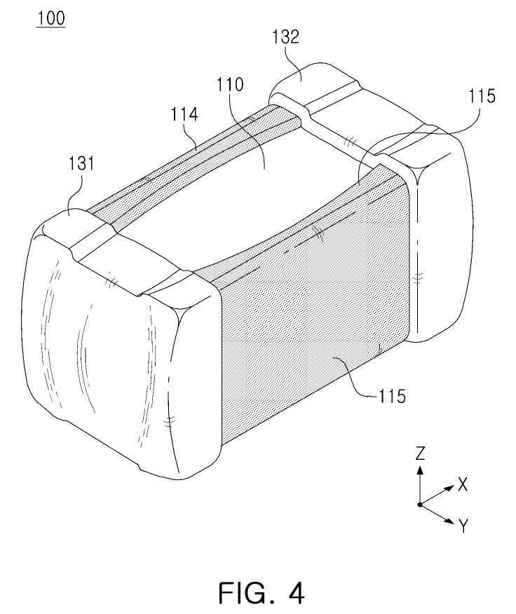

FIG. 4 is a schematic perspective view of a multilayer electronic component according to a method for manufacturing a multilayer electronic component according to an embodiment of the present disclosure.

Hereinafter, a multilayer electronic component according to an embodiment of the present disclosure will be described in detail with reference to FIGS. 1 to 4. However, a multilayer ceramic capacitor will be described as an example of a multilayer electronic component, but the example embodiment may also be applied to various electronic products using a dielectric composition, such as an inductor, a piezoelectric element, a varistor, a thermistor, or the like.

A method for manufacturing a multilayer electronic component 100 according to an embodiment of the present disclosure may include preparing a ceramic green sheet 211 having internal electrode patterns 221 and 222 formed thereon (S100); preparing a multilayer ceramic green sheet 220 by stacking the ceramic green sheet 211 in a first direction(S200); preparing a green body 210 by cutting the multilayer ceramic green sheet 220 so that the internal electrode patterns 221 and 222 are exposed in a third direction, when a direction, perpendicular to the first direction is referred to as a second direction, and a direction, perpendicular to the first and second directions is referred to as the third direction(S300); attaching a margin portion green sheet 215 to the green body 210 in the third directions 5 and 6 under first process condition(S400); and performing a punching process on the green body 210 to which the margin portion green sheet 215 is attached under second process condition(S500), wherein, after the performing the punching process (S500), the margin portion green sheet 215 may have a structure extending onto at least one surface of both surfaces 1 and 2 of the green body 210 in the first direction and both surfaces 3 and 4 of the green body 210 in the second direction.

A method for manufacturing a multilayer electronic component 100 according to another embodiment of the present disclosure may include preparing a ceramic green sheet 211 having internal electrode patterns 221 and 222 formed thereon (S100); preparing a multilayer ceramic green sheet 220 by stacking the ceramic green sheet 211 in a first direction(S200); preparing a green body 210 by cutting the multilayer ceramic green sheet 220 so that the internal electrode patterns 221 and 222 are exposed in a third direction, when a direction, perpendicular to the first direction is referred to as a second direction, and a direction, perpendicular to the first and second directions is referred to as the third direction (S300); attaching a margin portion green sheet 215 to the green body 210 in the third directions 5 and 6 under first process condition(S400); and performing a punching process on the green body 210 to which the margin portion green sheet 215 is attached under second process condition (S500), wherein the first process condition may include applying a pressure condition of 0.1 tons or more and 1.2 tons or less, and a temperature condition of 60°C or more and 120°C or less, and the second process condition may include a pressure condition of 5 tons or more and 12 tons or less, and a temperature condition of 20°C or more and 60°C or less.

P reparing a ceramic green sheet having an internal electrode pattern formed there o n (S100)

As shown in FIG. 2A, a plurality of stripe-shaped first internal electrode patterns 221 may be formed at a predetermined interval on a ceramic green sheet 211. The plurality of stripe-shaped first internal electrode patterns 221 may be formed parallel to each other, and a ceramic green sheet having the first internal electrode patterns 221 formed thereon are formed may be defined as a first ceramic green sheet.

The ceramic green sheet 211 may include a ceramic slurry including a ceramic material, an organic solvent, and an organic binder. A ceramic material is not particularly limited, as long as the ceramic material has a high dielectric constant, but a perovskite (ABO₃)-based material may be used, and for example, a barium titanate-based material, a lead composite perovskite-based material, a strontium titanate-based material, or the like can be used. The barium titanate-based material may include a BaTiO₃-based ceramic powder, and examples of the ceramic powder may include BaTiO₃, or (Ba₁₋ₓCaₓ)TiO₃(0<x<1), Ba(Ti_{1-y}Ca_{y})O₃(0<y<1), (Ba₁₋ₓCaₓ)(Ti_{1-y}Zr_{y})O₃(0<x<1, 0<y<1), Ba(Ti_{1-y}Zr_{y})O₃(0<y<1), or the like, in which calcium (Ca), zirconium (Zr), or the like, is partially dissolved in BaTiO₃, or the like.

The stripe-shaped first internal electrode pattern 221 may be formed by a paste for internal electrodes including a conductive metal. The conductive metal is not particularly limited, but a material with excellent electrical conductivity can be used.

The first internal electrode pattern 221 may be formed on a first ceramic green sheet using a screen printing method, a gravure printing method, or the like, but an embodiment of the present disclosure is not limited thereto.

In addition, although not shown, a plurality of stripe-shaped second internal electrode patterns 222 may be formed at a predetermined interval on the other ceramic green sheet 211, and a ceramic green sheet having the second internal electrode patterns 222 formed thereon may be defined as a second ceramic green sheet.

P reparing a multilayer ceramic green sheet (S200)

Next, as illustrated in FIG. 2B, first and second ceramic green sheet may be alternately stacked in a first direction, so that a stripe-shaped first internal electrode pattern 221 and a stripe-shaped second internal electrode pattern 222 are cross-stacked.

In this case, a portion in which a ceramic green sheet 211 and the stripe-shaped internal electrode patterns 221 and 222 are stacked in a first direction to form capacitance may be defined as a green capacitance forming portion, and cover portion green sheets 212 and 213 may be disposed on both end surfaces of the green capacitance forming portion in the first direction.

Specifically, the cover portion green sheets 212 and 213 may include a first cover portion green sheet 212 disposed on one end surface of the green capacitance forming portion in a first direction and a second cover portion green sheet 213 disposed on the other end surface of the green capacitance forming portion in the first direction, and more specifically, may include a first cover portion green sheet 212 disposed below the green capacitance forming portion in the first direction and a second cover portion green sheet 213 disposed above the green capacitance forming portion in the first direction.

After performing a sintering process, the ceramic green sheet 211 may be a dielectric layer 111, the stripe-shaped first internal electrode pattern 221 may be a first internal electrode 121, and the stripe-shaped second internal electrode pattern 222 may be a second internal electrode 122. In addition, the first cover portion green sheet 212 may be a first cover portion 112, and the second cover portion green sheet 213 may be a second cover portion 113.

A thickness “td” of the ceramic green sheet 211 does not need to be particularly limited, and the description of the thickness “td” of the ceramic green sheet may correspond to the description of the thickness “td” of each of the first ceramic green sheet and the second ceramic green sheet.

In order to more easily achieve miniaturization and high capacitance, the thickness “td” of the ceramic green sheet 211 may be 1.0 μm or less, 0.8 μm or less, preferably 0.6 μm or less, 0.5 μm or less, and more preferably 0.45 μm or less, 0.4 μm or less.

Here, the thickness “td” of the ceramic green sheet may refer to a size of the ceramic green sheet in the first direction.

A thickness “te” of the internal electrode patterns 211 and 212 does not need to be particularly limited, and the description of the thickness “te” of the internal electrode patterns 211 and 212 may correspond to the description of the thickness “te” of each of the first internal electrode pattern 211 and the second internal electrode pattern 222.

In order to more easily achieve miniaturization and high capacitance, the thickness “te” of the internal electrode pattern may be 1.0 μm or less, 0.8 μm or less, preferably 0.6 μm or less, 0.5 μm or less, and more preferably 0.45 μm or less, 0.4 μm or less.

FIG. 2C is a cross-sectional view illustrating a ceramic green sheet 220 in which first and second ceramic green sheet are stacked in a first direction, and FIG. 2D is a schematic perspective view of the multilayer ceramic green sheet 220.

Referring to FIGS. 2C and 2D, a first ceramic green sheet having a plurality of parallel stripe-shaped first internal electrode patterns 221 printed thereon and a second ceramic green sheet having a plurality of parallel stripe-shaped second internal electrode patterns 222 printed thereon are alternately stacked.

More specifically, the first ceramic green sheet and the second ceramic green sheet may be stacked so that a gap between a central portion of the stripe-shaped first internal electrode pattern 221 printed on the first ceramic green sheet and the stripe-shaped second internal electrode pattern 222 printed on the second ceramic green sheet overlaps.

P reparing a green body (S300)

Next, as illustrated in FIG. 2D, a multilayer ceramic green sheet 220 may be cut across a plurality of stripe-shaped first internal electrode patterns 221 and a plurality of stripe-shaped second internal electrode patterns 222. That is, the multilayer ceramic green sheet 220 may be cut along C1-C1 and C2-C2 cutting lines, which are perpendicular to each other, and a plurality of green bodies 210 may be provided.

More specifically, the stripe-shaped first internal electrode pattern 221 and the stripe-shaped second internal electrode pattern 222 may be divided into a plurality of internal electrode patterns 211 and 222 having a constant size in a third direction along the C1-C1 cutting line. In this case, the ceramic green sheet 211 may also be cut into a plurality of pieces, together with the internal electrode patterns 221 and 222, to form a plurality of cut green bodies 210. Meanwhile, the sizes of the cut ceramic green sheet 211 and the cut internal electrode patterns 221 and 222 may be the same.

In addition, it can be cut to fit individual body sizes along the C2-C2 cutting line. That is, before attaching the margin portion green sheet 215, the bar-shaped laminated ceramic green sheet 220 may be cut to individual ceramic body sizes along the C2-C2 cutting line.

Thereafter, as shown in FIG. 2E, a green body 210 may be prepared.

A ttaching a margin portion green sheet (S400)

Meanwhile, in order to implement miniaturization and high capacitance of a multilayer electronic component, an internal electrode may be exposed in a width direction of a body, to maximize an area of the internal electrode in the width direction by a margin-free design, but, in an operation before sintering, after manufacturing such a chip, a method in which a margin portion green sheet is separately attached to an exposed surface of the electrode of the green body in the width direction, is being applied.

According to the conventional method of forming a margin portion, in order to attach the margin portion green sheet to the cut surface of the green body in the width direction, it was performed by attaching the margin portion green sheet to the green body, then applying heat and pressure to compress the same, and then punching out a portion of the margin portion green sheet that was not attached to the green body to remove the remaining margin portion green sheet.

In this case, the remaining margin portion green sheet was removed so that the attached margin portion green sheet was identical to the first direction of the green body, and the margin green sheet was manufactured so that the margin portion green sheet was not attached to both surfaces of the green body in the first direction (first and second surfaces) or both surfaces of the green body in the second direction (third and fourth surfaces).

However, a structure of the margin portion green sheet has a structure in which an interface between the green body and the margin portion green sheet is exposed to the outside, and even after sintering, an open path exists through which external moisture can penetrate the interface between the body and the margin portion, which has always caused moisture-resistant reliability problems in a multilayer electronic component.

Accordingly, according to a method for manufacturing a multilayer electronic component according to an embodiment of the present disclosure, the moisture resistance reliability of a multilayer electronic component may be improved, by minimizing a region in which the interface between the body and the margin portion is exposed to the outside, or increasing a path for external moisture penetration in the manufactured laminated electronic component. Hereinafter, a specific manufacturing method thereof will be described.

Next, as shown in FIG. 2F, a margin portion green sheet 215 may be attached to a green body 210 in a third direction under first process condition.

In the drawings, it is illustrated that a margin portion green sheet 215 is attached to one surface (e.g., sixth surface) of the green body 210 in the third direction, but the margin portion green sheet may also be attached to the other surface thereof (e.g., fifth surface) in the third direction. In this case, when attaching the margin portion green sheet to the other surface (e.g., the fifth surface) of the green body 210 in the third direction, it may be performed after the operation of attaching the margin portion green sheet 215 to one surface (e.g., sixth surface) thereof in the third direction, and a punching operation described later.

A margin portion green sheet attached to the fifth surface 5 may be referred to as a first margin portion green sheet, and a margin portion green sheet attached to the sixth surface 6 may be referred to as a second margin portion green sheet 215, and the first and second margin portion green sheets may be first and second margin portions 114 and 115 after sintering, respectively.

The first process condition may include a pressure condition of 0.1 tons or more and 1.2 tons or less and/or a temperature condition of 60°C or more and 120°C or less, and it may be preferable to apply both the pressure condition and the temperature condition to the first process condition.

By attaching the margin portion green sheet 215 under the first process condition, the margin portion green sheet 215 may have a structure extending onto at least one surface among the surfaces 1 and 2 of the green body 210 in a first direction and the surfaces 3 and 4 of the green body 210 in a second direction.

In the present disclosure, at least one surface among the surfaces of the green body 210 in the first direction and the surfaces of the green body 210 in the second direction may mean at least one surface of the first and second surfaces 1 and 2 or the third and fourth surfaces 3 and 4, and may mean that the margin portion green sheet has a structure extending onto at least one surface of the first to fourth surfaces 1, 2, 3, and 4 of the green body. For example, a second margin portion green sheet 215 disposed on the sixth surface 6 may have a structure extending onto at least one surface of the first to fourth surfaces 1, 2, 3, and 4, and a first margin portion green sheet disposed on the fifth surface 5 may have a structure extending onto at least one surface of the first to fourth surfaces 1, 2, 3, and 4. In this case, it may be preferable that the first and second margin portion green sheets are spaced apart from each other, but this is not limited thereto.

Meanwhile, the margin portion green sheet 215 may be attached using a first heating pressure member.

For example, a margin portion green sheet 215 and a green body 210 may be disposed between a 1-1 heating pressure member and a 1-2 heating pressure member, and then compressed and attached.

The 1-1 heating pressure member may include a first lower steel sheet 311a and a first elastic member 312 disposed on an upper surface of the first lower steel sheet 311a, and the 1-2 heating pressure member may include a first upper steel sheet 311b and a first adhesive sheet 312 disposed on a lower surface of the first upper steel sheet 311b.

Here, the first elastic member 312 may include a soft elastomer, and may preferably be a soft elastomer.

Here, the soft elastomer may preferably have an elastic modulus of more than 50 Mpa, and more specifically, for example, may include at least one selected from the group consisting of natural rubber, neoprene rubber, silicone rubber, polyurethane, Ethylene Propylene Diene Monomer (EPDM), Styrene-Butadiene Rubber (SBR), polybutadiene, and a thermoplastic elastomer, but an embodiment thereof is not limited thereto.

The first elastic member 312 may have a structure extending onto at least one surface among the surfaces (first and second surfaces) of the green body 210 in the first direction and the surfaces (third and fourth surfaces) of the green body 210 in the second direction.

This may be because, when heating and pressing are performed to attach the margin portion green sheet 215 to the green body 210, the green body 210 is drawn in a direction of the first elastic member 312 together with the margin portion green sheet 215 and the first elastic member 312, and is attached to other surfaces including a surface of the green body 210 in the third direction.

When attaching the margin portion green sheet 215, when pressed with a pressure of less than 0.1 ton or heated with a temperature of less than 60°C, there is a concern that the margin portion green sheet 215 may not extend onto at least one surface among the surfaces of the green body 210 in the first direction and the surfaces of the green body 210 in the second direction, and when pressed with a pressure of exceeding 1.2 tons or heated with a temperature of exceeding 120°C, there is a concern that excessive pressure may be applied to the green body 210, causing deformation and resulting in defects in the manufactured multilayer electronic component.

In this case, the temperature condition of 60°C or more and 120°C or less among the first process condition may refer to a temperature of a first lower steel sheet 311a. This is because a temperature of the first elastic member 312 changes depending on the temperature of the first lower steel sheet 311a, and a temperature of the margin portion green sheet 215 changes depending on the temperature of the first elastic member 312, so that deformation may be easily achieved when the margin portion green sheet 215 is attached to the green body 210.

In addition, the pressure condition of 0.1 tons or more and 1.2 tons or less among the first process condition may mean applying pressure to the green body 210 using the upper first steel sheet 311b.

P erforming a punching process (S500)

Next, as shown in FIG. 2G, a punching process may be performed on a green body 210 to which a margin green sheet 215 is attached under a second process condition.

The second process condition may include a pressure condition of 5 tons or more and 12 tons or less and/or a temperature condition of 20°C or more and 60°C or less, and it may be preferable to apply both the pressure condition and the temperature condition to the second process condition.

By performing a punching process under the second process condition, a remaining margin green sheet 215' extending onto at least one surface among both surfaces 1 and 2 of the green body 210 in the first direction and both surfaces 3 and 4 of the green body 210 in the second direction may be easily detached and removed.

In this case, the first process condition and the second process condition may have different pressure conditions, or the first process condition and the second process condition may have different temperature conditions, and the first process condition and the second process condition may have different pressure conditions and temperature conditions.

Meanwhile, the punching process may be performed using a second heating pressure member.

For example, a green body 210 having a margin green sheet 215 attached thereto may be disposed between a 2-1 heating pressure member and a 2-2 heating pressure member, and then compressed and punched.

The 2-1 heating pressure member may include a second lower steel sheet 411a and a second elastic member 412 disposed on an upper surface of the second lower steel sheet 411a, and the 2-2 heating pressure member may include a second upper steel sheet 411b and a second adhesive sheet 412 disposed on a lower surface of the second upper steel sheet 411b.

Here, the second elastic member 412 may include an elastomer, and it may be preferable that the second elastic member 412 be an elastomer having a lower elastic modulus than the first elastic member 312.

When attaching the margin green sheet 215, when a pressure of less than 5 tons is applied or a temperature of less than 20°C is applied, there is a concern that an unnecessary margin portion green sheet 215 may not be detached from the green body 210 having the margin portion green sheet 215 attached thereto, and when pressed with a pressure exceeding 12 tons or heated to a temperature exceeding 60°C, there is a risk of damage to the green body 210 or excessive deformation of the margin portion green sheet 215, resulting in poor adhesion to the green body 210.

In this case, the temperature condition of 20°C or more and 60°C or less of the second process condition may refer to a temperature of a second lower steel sheet 411a. This means that the temperature of the second elastic member 412 changes depending on the temperature of the second lower sheet 411a, and the temperature of the margin portion green sheet 215 changes depending on the temperature of the second elastic member 412, so that when a punching process is applied to the green body 210 to which the margin portion green sheet 215 is attached, detachment and removal of the remaining margin green sheet 215' may be easily performed, but an embodiment thereof is not limited thereto.

In addition, the pressure condition of 5 tons or more and 12 tons or less of the second process condition may mean applying pressure to the green body 210 using the upper second steel sheet 411b.

Hereinafter, a multilayer electronic component 100 will be briefly described.

The multilayer electronic component 100 may include a body 110, and the body 110 may have a dielectric layer 111 and internal electrodes 121 and 122 alternately stacked.

The internal electrodes 121 and 122 may include a first internal electrode 121 and a second internal electrode 122, and the first and second internal electrodes 121 and 122 may be alternately disposed to face each other with a dielectric layer 111 forming the body 110 interposed therebetween.

The body 110 may include cover portions 112 and 113 disposed on both end surfaces of a capacitance forming portion (Ac).

The multilayer electronic component 100 may include margin portions 114 and 115 disposed on both end surfaces of the body 110 in the third direction.

More specifically, the margin portions 114 and 115 may include first and second margin portions 114 and 115 respectively disposed on the fifth and sixth surfaces 5 and 6, and the first and second margin portions 114 and 115 may extend onto the first and second surfaces 1 and 2 and the third and fourth surfaces 3 and 4, respectively, and at least one surface. That is, the first margin portion 114 may be disposed on the third surface 3 and may extend from the third surface 3 onto at least one of the first to fourth surfaces 1, 2, 3, and 4, and the second margin portion 115 may extend from the fourth surface 4 onto at least one of the first to fourth surfaces 1, 2, 3, and 4.

The multilayer electronic component 100 may include external electrodes 131 and 132 disposed on the body 110 and connected to the internal electrodes 121 and 122.

A size of the multilayer electronic component 100 does not need to be particularly limited.

However, to achieve both miniaturization and high capacitance, thicknesses of the dielectric layer and internal electrodes should be thinned to increase the number of stacks. Therefore, an effect according to the present disclosure may become more noticeable in a multilayer electronic component 100 having a size of 2012 (length × width: 2.0 mm × 1.2 mm, and length and width satisfy an error of within ±10%) or less. In addition, the multilayer electronic component 100 may have a width greater than a length.

As set forth above, according to one of the many effects of the present disclosure, moisture resistance reliability of a multilayer electronic component may be improved.

According to one of many effects of the present disclosure, dielectric properties per unit volume of a multilayer electronic component may be improved.

However, various advantages and effects of the present disclosure are not limited to the above-described contents, and can be more easily understood in a process of explaining specific embodiments of the present disclosure.

Although the embodiments of the present disclosure have been described in detail above, the present disclosure is not limited by the above-described embodiments and the attached drawings, but is intended to be limited by the appended claims. Accordingly, various forms of substitution, modification, and change may be made by those skilled in the art within the scope that does not depart from the technical idea of the present disclosure described in the claims, and this will also fall within the scope of the present disclosure.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it can be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

While example embodiments have been illustrated and described above, it will be apparent to those skilled in the art that modifications and variations could be made without departing from the scope of the present disclosure as defined by the appended claims.

What is claimed is:

1. A method for manufacturing a multilayer electronic component, comprising:
preparing a ceramic green sheet having an internal electrode pattern formed thereon;
preparing a multilayer ceramic green sheet by stacking the ceramic green sheet in a first direction;
preparing a green body by cutting the multilayer ceramic green sheet so that the internal electrode pattern is exposed in a third direction, wherein a direction perpendicular to the first direction is referred to as a second direction, and a direction, perpendicular to the first and second directions is referred to as the third direction;
attaching a margin portion green sheet to the green body in the third direction under a first process condition; and
performing a punching process on the green body to which the margin portion green sheet is attached under a second process condition,
wherein, after the performing the punching process, the margin portion green sheet has a structure extending onto at least one surface among surfaces of the green body in the first direction and surfaces of the green body in the second direction.

2. The method for manufacturing a multilayer electronic component of claim 1,
wherein the first process condition and the second process condition have different pressure conditions.

3. The method for manufacturing a multilayer electronic component of claim 1,
wherein the first process condition and the second process condition have different temperature conditions.

4. The method for manufacturing a multilayer electronic component of claim 1,
wherein the first process condition includes applying a pressure condition of 0.1 ton or more and 1.2 ton or less.

5. The method for manufacturing a multilayer electronic component of claim 1,
wherein the first process condition includes applying a temperature condition of 60°C or more and 120°C or less.

6. The method for manufacturing a multilayer electronic component of claim 1,
wherein the attaching the margin portion green sheet is performed by compressing the green body onto a steel sheet, an elastic member disposed on the steel sheet, and a margin portion green sheet disposed on the elastic member, and
the elastic member includes a soft elastomer.

7. The method for manufacturing a multilayer electronic component of claim 6,
wherein the soft elastomer has an elastic modulus of more than 50 Mpa.

8. The method for manufacturing a multilayer electronic component of claim 6,
wherein the soft elastomer comprises at least one selected from the group consisting of natural rubber, neoprene rubber, silicone rubber, polyurethane, Ethylene Propylene Diene Monomer (EPDM), Styrene-Butadiene Rubber (SBR), polybutadiene, and thermoplastic elastomer.

9. The method for manufacturing a multilayer electronic component of claim 1,
wherein the second process condition includes applying a pressure condition of 5 tons or more and 12 tons or less.

10. The method for manufacturing a multilayer electronic component of claim 1,
wherein the second process condition includes applying a temperature condition of 20°C or more and 60°C or less.

11. A method for manufacturing a multilayer electronic component, comprising:
preparing a ceramic green sheet having an internal electrode pattern formed thereon;
preparing a multilayer ceramic green sheet by stacking the ceramic green sheets in a first direction;
preparing a green body by cutting the multilayer ceramic green sheet so that the internal electrode pattern is exposed in a third direction, wherein a direction perpendicular to the first direction is referred to as a second direction, and a direction, perpendicular to the first and second directions is referred to as the third direction;
attaching a margin portion green sheet to the green body in the third direction under first process condition; and
performing a punching process on a green body to which the margin portion green sheet is attached under second process condition,
wherein the first process condition includes applying a pressure condition of 0.1 tons or more and 1.2 tons or less, and a temperature condition of 60°C or more and 120°C or less, and
the second process condition includes applying a pressure condition of 5 tons or more and 12 tons or less, and a temperature condition of 20°C or more and 60°C or less.

12. The method for manufacturing a multilayer electronic component of claim 11,
wherein, after the performing the punching process, the margin portion green sheet has a structure extending onto at least one surface among surfaces of the green body in the first direction and surfaces of the green body in the second direction.

13. The method for manufacturing a multilayer electronic component of claim 11,
wherein the attaching the margin portion green sheet is performed by compressing the green body onto a steel sheet, an elastic member disposed on the steel sheet, and a margin portion green sheet disposed on the elastic member, and
the elastic member includes a soft elastomer.

14. The method for manufacturing a multilayer electronic component of claim 13,
wherein the soft elastomer has an elastic modulus of more than 50 Mpa.

15. The method for manufacturing a multilayer electronic component of claim 13,
wherein the soft elastomer comprises at least one selected from the group consisting of natural rubber, neoprene rubber, silicone rubber, polyurethane, Ethylene Propylene Diene Monomer (EPDM), Styrene-Butadiene Rubber (SBR), polybutadiene, and thermoplastic elastomer.
